(19) United States
(12) Patent Application Publication
(10) Pub. No.: US 2017/0024224 A1
(43) Pub. Date: Jan. 26, 2017

(54) DYNAMIC SNAPSHOTS FOR SHARING NETWORK BOOT VOLUMES

(71) Applicant: Cisco Technology, Inc., San Jose, CA (US)

(72) Inventors: Mark Bakke, Maple Grove, MN (US); Timothy Kuik, Lino Lakes, MN (US); David Thompson, Rogers, MN (US)

(21) Appl. No.: 14/806,408

(22) Filed: Jul. 22, 2015

(51) Int. Cl. G06F 9/44

(52) U.S. Cl. CPC G06F 9/4416

(57) ABSTRACT

The subject technology addresses the need in the art for improving provisioning and booting of virtual machines in a cloud computing environment. Different versions of boot volume images may be shared in a storage repository accessible by one or more host computers. When a virtual machine is created, a shared boot volume image, including confirmation information for the virtual machine, may be selected for booting the virtual machine. Over time, newer version(s) of boot volume images may be stored in the storage repository and new virtual machine(s) may use the newer version of the boot volume image for booting.

### BACKGROUND

Virtualization is a technology that allows one computer to do the job of multiple computers by sharing resources of a single computer across multiple systems. Through the use of virtualization, multiple operating systems and applications can run on the same computer at the same time, thereby increasing utilization and flexibility of hardware. Virtualization allows servers to be decoupled from underlying hardware, thus resulting in multiple virtual machines sharing the same physical server hardware. The virtual machines may move between servers based on traffic patterns, hardware resources, or other criteria. The speed and capacity of today's servers allow for a large number of virtual machines on each server, and in large data centers there may also be a large number of servers.

### BRIEF DESCRIPTION OF THE DRAWINGS

The embodiments of the present technology will hereinafter be described in conjunction with the appended drawings, provided to illustrate and not to limit the technology, wherein like designations denote like elements, and in which:

FIG. 1 is an example computing environment 100 in accordance with at least one embodiment;

FIG. 2 illustrates an example conceptual diagram of performing read and write operations using portions of the computing environment described by reference in FIG. 1;

FIG. 3 conceptually illustrates an example process to load a shared boot volume in accordance with embodiments of the subject technology;

FIG. 4 illustrates an example network device according to some aspects of the subject technology;

FIGS. 5A and 5B illustrate example system embodiments according to some aspects of the subject technology;

FIG. 6 illustrates a schematic block diagram of an example architecture for a network fabric; and

FIG. 7 illustrates an example overlay network.

### DETAILED DESCRIPTION

Systems and methods in accordance with various embodiments of the present disclosure may overcome one or more deficiencies experienced in existing approaches to provisioning and booting virtual machines.

### Overview

Embodiments of the subject technology provide for storing at a shared storage device, a plurality of boot volume images corresponding to an operating system; selecting a boot volume image from the plurality of boot volume images; for installing a new virtual machine: loading a first set of data into memory from the selected boot volume image, the first set of data including at least a boot loader enabled to load at least a portion of the operating system into the memory and perform a boot process for the new virtual machine; and storing, using an interface, a second set of data into the local storage device, the second set of data including data for executing the operating system after performing the boot process for the new virtual machine.

### DESCRIPTION OF EXAMPLE EMBODIMENTS

The disclosed technology addresses the need in the art for improving provisioning of virtual machines in a computing environment. More specifically, the disclosed technology addresses the need in the art for sharing a boot volume for multiple virtual machines.

### Examples of Using a Shared Boot Volume

Embodiments provide a way of provisioning virtual machines using a shared boot volume. By using a shared boot volume, storage resource usage may be reduced, and configuration and installation of virtual machines may be simplified.

Virtualization can transform physical hardware into software by creating multiple virtual machines on one or more physical computers or servers. The virtual machines that are on the same physical computer (e.g., a host computer) may share hardware resources without interfering with each other, thereby enabling multiple operating systems and other software applications to execute at the same time on a single physical computer, for example, by using a virtual machine hypervisor (“hypervisor”) to allocate hardware resources dynamically and transparently so that multiple operating systems can run concurrently on the single physical computer. A virtual machine is therefore understood as a tightly isolated software container that can run its own operating systems and applications as if it were a physical computer. A virtual machine, in an embodiment, behaves like a physical computer and contains its own virtual (e.g., software-based) hardware components such as CPU, GPU, RAM, hard disk, firmware and/or network interface card (NIC), among other types of virtual resources or components. In this fashion, utilization of hardware resources can be fully exploited and shared between multiple virtual machines without requiring redundant or additional hardware on the same physical computer.

In the context of information technology, cloud computing is a model of service delivery (e.g., instead of a product) for providing on-demand access to shared computing resources (e.g., networks, network bandwidth, servers, processing, memory, storage, applications, virtual machines, virtual appliances, and services) that can be provisioned with very little management effort or interaction with a provider of the service. In a cloud computing environment, requests for provisioning virtual machines may be received by the hypervisor (or computer that the hypervisor is executing on). The hypervisor is also called a virtual machine monitor (VMM) in some instances. The hypervisor, in an embodiment, may be a software, firmware, hardware, or any combination thereof that creates and runs virtual machines on one or more computers.

A large number of computers within the cloud computing environment may have a number of virtual machines, each with varying configurations and applications running in them. The demands for specific configurations of operating systems and applications may arise unpredictably. Provisioned virtual machines may, for example, be needed for only a few minutes for some environments (for example, quality assurance testing, short-term usage, etc.), a few days (for example, simulations, analyzing data, rendering graphics, etc.), or for longer periods (for example, in a datacenter environment). The following description provide techniques for using a share boot volume repository for booting a virtual machine, and for performing subsequent read and/or write operations using a combination of local storage and the shared boot volume repository.

### Example Network Environment

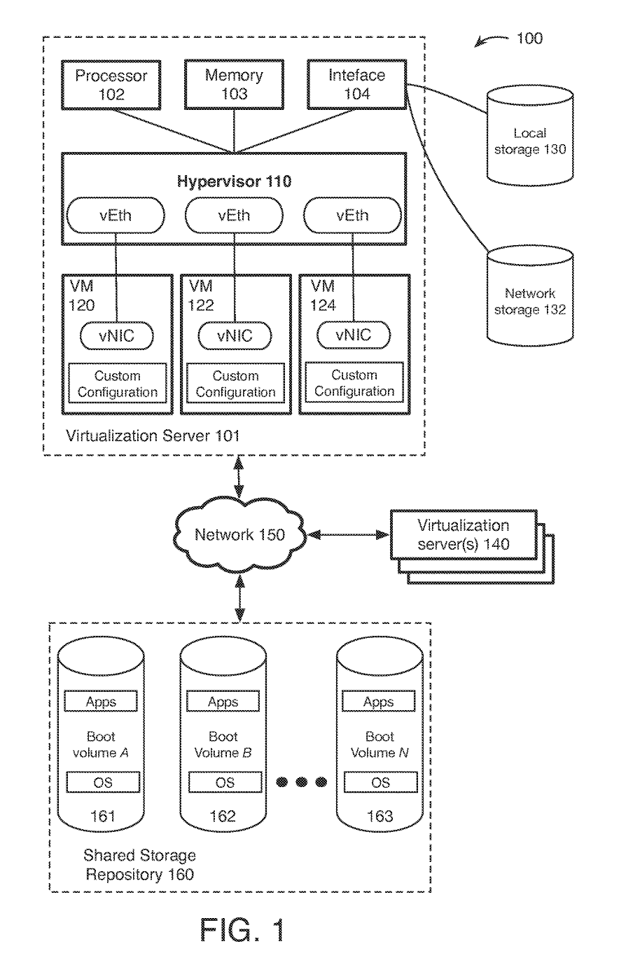

FIG. 1 is an example computing environment 100 in accordance with at least one embodiment. As illustrated, the computing environment 100 includes a virtualization server 101 (e.g., a host server or computing device where one or more virtual machines are provisioned and run on), a local storage 130 for the virtualization server 101, and a network storage 132 that is accessible over a network (e.g., the Internet, virtual private network (VPN), LAN, WAN, etc.) by the virtualization server 101. In an embodiment, the local storage 130 and network storage 132 could be a network attached storage (NAS), storage area network (SAN), distributed storage device, or respective storage servers. Local storage 130 may be a dedicated storage for the virtualization server 101, and the network storage 132 may provide storage accessible by other virtualization servers (not shown in FIG. 1).

The virtualization server 101 includes hardware components of a server, and may be provided as a cluster or array of multiple servers in an example. The virtualization server 101 hosts virtual machines 120, 122, and 124 that share hardware resources of the virtualization server 101, including processor 102, memory 103, and interface 104. The interface 104 may be a bus interface, disk interface, a network file system interface, host adaptor, or host bus adaptor, etc., which enables the virtualization server 100 to access and communicate with the local storage 130 and the network storage 132. Although a number of virtual machines are included in the illustrative example of FIG. 1, it is appreciated that any number of virtual machines are contemplated within the scope of the disclosure. Further, the virtualization server 101 may include other or additional hardware components not illustrated in FIG. 1. As further shown in FIG. 1, other virtualization server(s) 140 are included in the computing environment 100 but the description of these other virtualization servers, which may include similar (or the same) components as the virtualization server 100, are not included herein for clarity of the example described further below. However, embodiments described herein contemplate the usage of multiple virtualizations servers in accordance with aspects of the disclosure and the example of a single virtualization server discussed in FIG. 1 is not intended to limit the scope of the disclosure in any way.

In an embodiment, a hypervisor 110 may be implemented as a software layer between the hardware resources of the virtualization server 101 and the virtual machines 120, 122, and 124. The hypervisor 110 therefore may be understood as a software component, running on the native operating system of the virtualization server 101, that manages (among other operations) the sharing and using of hardware resources, as provided by the virtualization server 101, by each of the virtual machines 120, 122, and 124. The hypervisor 110 performs operations to virtualize the resources of a virtual machine, such as a number of virtual CPUs, an amount of virtualized memory, virtual disks, and virtual interfaces, etc. Virtualized resources or components are software abstractions representing corresponding physical hardware components, in which operations performed by such virtualized resources are ultimately carried out on the given hardware components of the virtualization server 101.

Each of the virtual machines 120, 122, and 124 includes an operating system and one or more applications that run on top of the operating system. The operating system within a virtual machine may be a guest operating system (e.g., different than the native operating system of the virtualization server 101) that the applications in the virtual machine run upon. In an embodiment, a virtual disk for each of the virtual machines 120, 122, and 124 may be provided in the local storage unit 130 and/or the network storage 132. It will be appreciated that various operating systems may be running on each of the virtual machines. Similarly, various applications may be running within the virtual machines. In an example, a virtual machine may be stored as a set of files in a logical container called as data store on the local storage unit 130.

In an embodiment, the hypervisor 110 performs the functionality of a virtual switch for connecting to one or more virtual machines, and enabling local switching between different virtual machines within the same server. A virtual switch enables virtual machines to connect to each other and to connect to parts of a network. The hypervisor 110 may provide one or more Virtual Ethernet (vEthernet or vEth) interfaces in which each vEthernet interface corresponds to a switch interface that is connected to a virtual port. Each of the virtual machines 120, 122, and 124 may include a virtual Network Interface Cards (vNIC) that are connected to a virtual port of a respective vEthernet interface provided by the hypervisor 110.

Additionally, as mentioned before, the hypervisor 110 is capable of provisioning new virtual machines including at least configuration and installation of such virtual machines, and installation of applications on the virtual machines. The hypervisor 110 uses a configuration for a virtual machine that includes information for the operating system, virtualized resources, and application(s) to be installed for the virtual machine. In a typical approach, based on the configuration, an operating system for a virtual machine may be installed by using physical media or an image of the operating system stored locally in a host computer or in a location in the network. This typical approach copies the necessary files into the virtual machine's virtual disk (e.g., as stored physical storage of a host computer) with the downside of requiring redundant files and additional copy operations for each virtual machine that uses the same operating system. To address this problem, embodiments described herein access a shared boot volume images that may be stored in a shared storage repository 160. Each of the shared boot volume images may represent a respective “snapshot” of a boot volume with a respective set of files (e.g., corresponding to a particular version of such files) corresponding to a golden image or template for a virtual machine. In an embodiment, as used herein, a shared boot volume includes operating system data, files for booting a virtual machine, and/or applications and settings. The shared boot volume therefore is understood, in an embodiment, to include a specific configuration for deploying a virtual machine, which when accessed, may obviate the requirement for copying or cloning the boot volume onto a local virtual disk as previously used in the typical scenario for virtual machine deployment. In this regard, the shared boot volume may include files and executable code to configure the virtualized hardware and start a boot procedure for the operating system. For example, the boot volume may include a software component called a boot loader that processes at least a portion of the operations for the boot process.

Other custom configuration information, files, settings, applications, and/or operating system data, which represent further customization of the virtual machine from the shared boot volume image that is used, may be installed in a virtual disk, corresponding to the virtual machine, on physical storage provided by the virtualization server 101. As illustrated, custom configuration information may be stored within the respective virtual disks of the virtual machines 120, 122, and 124. Write operations for the virtual machine may occur in the virtual disk, and read operations may occur from the shared boot volume image and/or the virtual disk as explained in further detail below.

As part of provisioning a virtual machine, the hypervisor 110 may select a boot volume image, which includes files and data needed to boot the virtual machine upon being “powered” on. The selection may be based on several factors including a specific indication of the boot volume to be selected, or alternatively, the hypervisor 110 may determine the newest boot volume image for the operating system to use. Changes to the boot volume image may be captured in different images of the boot volume (e.g., snapshots as discussed before). The shared storage repository 160 therefore provides multiple snapshots of the selected boot volume with changes to files and/or data of the boot volume being captured and included a new boot volume image. Snapshots of the boot volume may be performed periodically, or when a threshold number of changes has been reached (e.g., a number of changes to files or data to the operating system meets the threshold number), among other types of rules for generating a new snapshot of a boot volume image.

In an embodiment, a new virtual machine may boot from the latest boot volume image ensuring that the new virtual machine uses the most up-to-date boot volume. Other data or files for executing the operating system (e.g., after the boot process is completed or that are not needed during the boot process) may be stored in a virtual disk corresponding to the virtual machine in the local storage 130.

In the example of FIG. 1, the virtual machine 120 may use a boot volume 161, the virtual machine 122 may use a boot volume 162, and the virtual machine 124 may use a boot volume 163. Each of the boot volumes may represent a respective boot volume image at a different time (e.g., in ascending newness or creation time).

When a virtual machine is “powered” on or booted, at least a portion of the operating system of the virtual machine is loaded into memory (e.g., the memory 103 provided by the virtualization server 101) according to a boot process. In an example, a virtualized system BIOS (Basic Input/Output System) or a virtualized Unified Extensible Firmware Interface (UEFI) may invoke a boot loader from the selected boot volume, which then initiates the process for loading the operating system into memory. Among other operations during the boot process, the boot loader may load a kernel of the operating system and drivers into memory from the boot volume. After the boot process has completed for the virtual machine, write operations to the virtual disk are performed on the virtual disk, but read operations to the virtual disk are performed depending on whether the virtual block on the virtual disk is mapped to the shared boot volume image or to local storage.

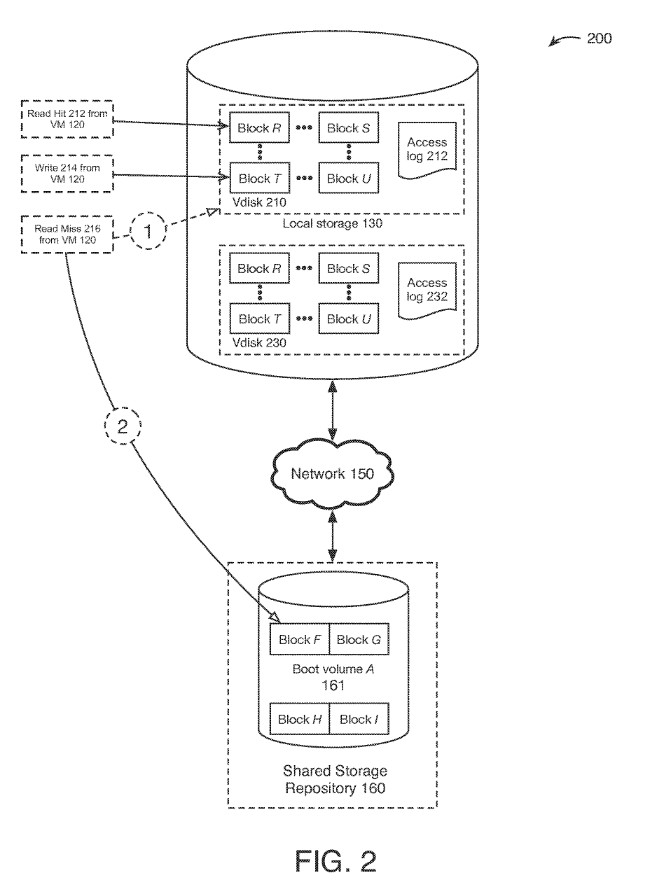

FIG. 2 illustrates an example 200 conceptual diagram of performing read and write operations using portions of the computing environment described by reference in FIG. 1. By reference to FIG. 1, operations performed by the virtual machine 120 on the local storage 130 of the virtualization server 101 and the shared storage repository 160 are illustrated with additional components shown in FIG. 2. Read and write operations are considered input/output (I/O) operations that may be performed by a virtual machine. As mentioned before, write operations for a virtual machine may occur in a virtual disk corresponding to the virtual machine, and read operations may occur from a shared boot volume image and/or the virtual disk as explained in the following discussion.

In the example of FIG. 2, the virtual machine 120 may perform a read operation 212 which results in a successful read hit in a virtual disk 210. For example, the read operation 212 may request a read of data including at least block R in the virtual disk 210. The virtual machine 120 may request a write operation in the virtual disk 210. Each operation performed by the virtual machine 120 may be stored in an access log 212 as a respective log entry.

As further shown in FIG. 2, the local storage 130 may also include a second virtual disk 230 with multiple blocks of data, and also an access log 232 that may include one or more log entries for read and write operations that are performed on the second virtual disk 230.

The virtual machine 120 may also attempt to perform a read operation 216 for a block that results in a read miss in the virtual disk 210. In an embodiment, the read miss indicates that the block is stored in a shared boot volume. Subsequently, the virtual machine 120 then attempts to perform the read operation 216 on the shared boot volume 161 stored across the network 150 in the shared storage repository 160. In this manner, it is contemplated that a hybrid use for read and write operations from the virtual machine 120 includes operations on the local storage 130 including the virtual disk 210, and in the case of a read operation miss also including performing a read operation on a shared boot volume in the shared storage repository 160.

In an example, an operation that results in a read miss may correspond to a request for data or information stored in a respective shared boot volume image in the shared storage repository 160. In an embodiment, the read operation may request a logical block address, which could reside on a virtual disk of a virtual machine (e.g., on the local storage 130), or in the shared boot volume. Through a mapping table or data structure, the logical block address is mapped to a physical block address in an example. The read operation may be performed, initially, on the virtual disk. For a read miss, in an example, the mapped physical block address may not be located in the virtual disk. Subsequently, the read operation is performed at the shared boot volume where the mapped physical block volume is located.

### Example Processes

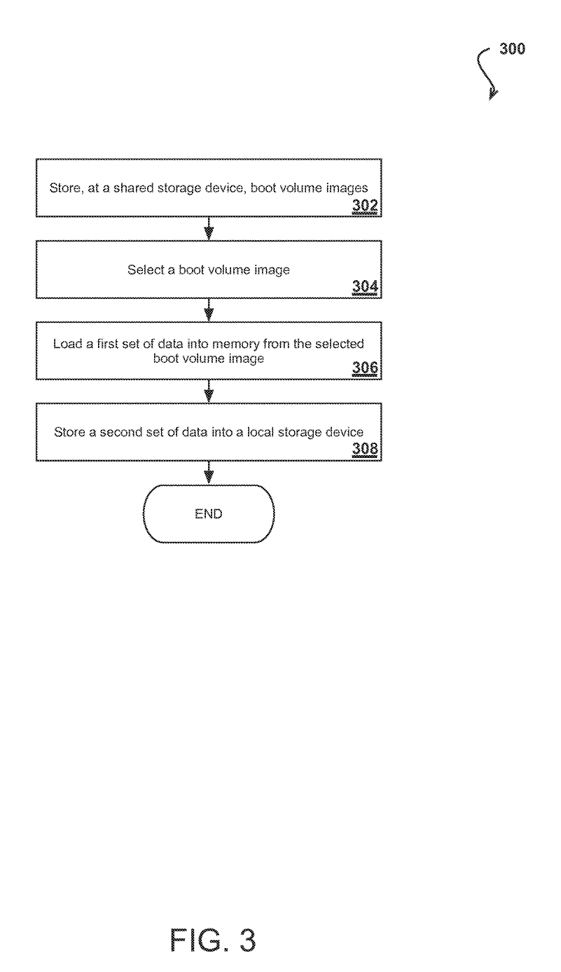

FIG. 3 conceptually illustrates an example process 300 to load a shared boot volume in accordance with embodiments of the subject technology. Referring to FIG. 1, the process 300 described below may be performed by a hypervisor that creates virtual machines as described before.

At step 302, a plurality of boot volume images corresponding to an operating system in respective configurations for a virtual machine are stored at a shared storage device. The plurality of boot volume images that are stored at the shared storage device may be located at a network location accessible by at least one other system or computing device.

At step 304, a boot volume image from the plurality of boot volume images is selected. The boot volume image includes at least configuration information (e.g., applications, settings, operating systems files and/or data) for a new virtual machine. Selecting the boot volume image is based at least in part on a time in which each of the plurality of boot volume images was created. For example, the newest boot volume image may be selected. Each of the plurality of boot volume images includes at least a version of a kernel of the operating system and a set of drivers in an example.

For installing the new virtual machine using the configuration information, at step 306, a first set of data is loaded into memory from the selected boot volume image, the first set of data including at least a boot loader enabled to load at least a portion of the operating system into the memory and perform a boot process for a new virtual machine. At step 308, a second set of data is stored into a local storage device, the second set of data including data for executing the operating system after performing the boot process for the new virtual machine. In a further embodiment, custom boot volume changes on behalf of a specific virtual machine may be stored. The process 300 may then end. It is understood that other operations may be performed as part of the boot process but are not described herein as they cover operations that are commonly performed and would obscure the focus of the above discussion.

### Example Devices, Systems and Architectures

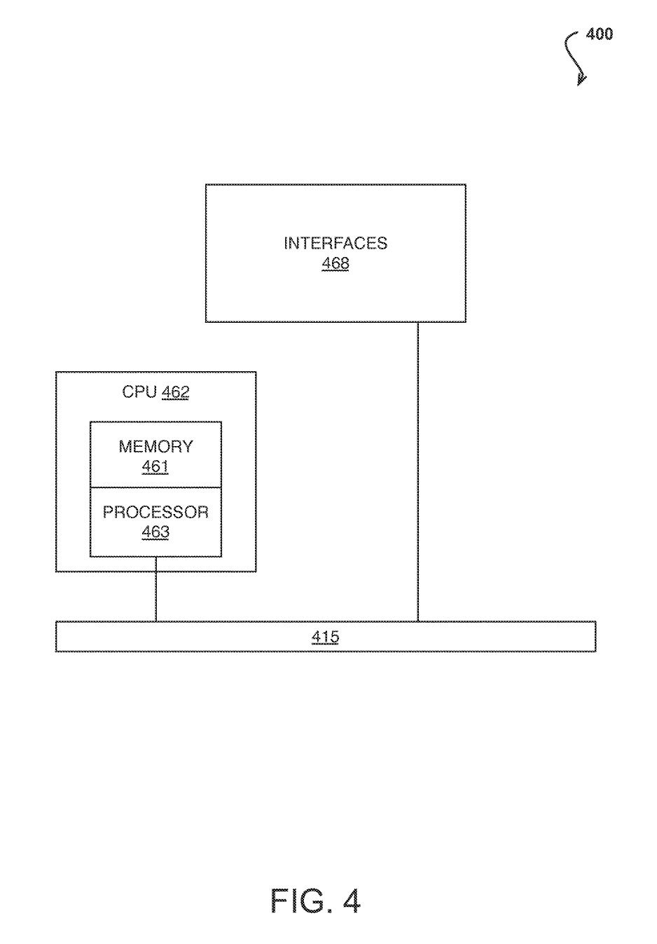

FIG. 4 illustrates an exemplary network device 400 suitable for implementing the present invention. Network device 400 includes a master central processing unit (CPU) 462, interfaces 468, and a bus 415 (e.g., a PCI bus). When acting under the control of appropriate software or firmware, the CPU 462 is responsible for executing packet management, error detection, and/or routing functions, such as miscabling detection functions, for example. The CPU 462 preferably accomplishes all these functions under the control of software including an operating system and any appropriate applications software. CPU 462 may include one or more processors 463 such as a processor from the Motorola family of microprocessors or the MIPS family of microprocessors. In a specific embodiment, a memory 461 (such as non-volatile RAM and/or ROM) also forms part of CPU 462. However, there are many different ways in which memory could be coupled to the system.

The interfaces 468 are typically provided as interface cards (sometimes referred to as “line cards”). Generally, they control the sending and receiving of data packets over the network and sometimes support other peripherals used with the router 400. Among the interfaces that may be provided are Ethernet interfaces, frame relay interfaces, cable interfaces, DSL interfaces, token ring interfaces, and the like. In addition, various very high-speed interfaces may be provided such as fast token ring interfaces, wireless interfaces, Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control such communications intensive tasks as packet switching, media control and management. By providing separate processors for the communications intensive tasks, these interfaces allow the master microprocessor 462 to efficiently perform routing computations, network diagnostics, security functions, etc.

Although the system shown in FIG. 4 is one specific network device of the present invention, it is by no means the only network device architecture on which the present invention can be implemented. For example, an architecture having a single processor that handles communications as well as routing computations, etc. is often used. Further, other types of interfaces and media could also be used with the router.

Regardless of the network device's configuration, it may employ one or more memories or memory modules (including memory 461) configured to store program instructions for the general-purpose network operations and mechanisms for roaming, route optimization and routing functions described herein. The program instructions may control the operation of an operating system and/or one or more applications, for example. The memory or memories may also be configured to store tables such as mobility binding, registration, and association tables, etc.

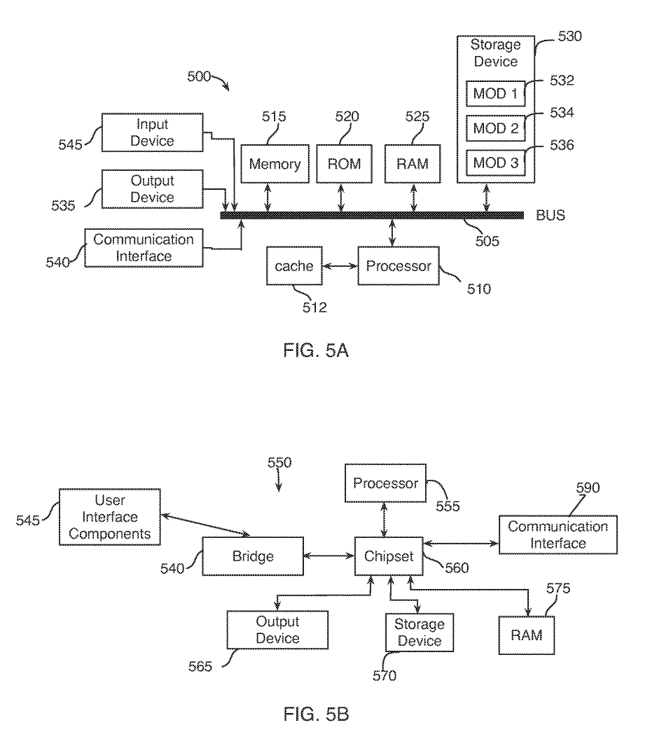

FIG. 5A, and FIG. 5B illustrate exemplary possible system embodiments. The more appropriate embodiment will be apparent to those of ordinary skill in the art when practicing the present technology. Persons of ordinary skill in the art will also readily appreciate that other system embodiments are possible.

FIG. 5A illustrates a conventional system bus computing system architecture 500 wherein the components of the system are in electrical communication with each other using a bus 505. Exemplary system 500 includes a processing unit (CPU or processor) 510 and a system bus 505 that couples various system components including the system memory 515, such as read only memory (ROM) 520 and random access memory (RAM) 525, to the processor 510. The system 500 can include a cache of high-speed memory connected directly with, in close proximity to, or integrated as part of the processor 510. The system 500 can copy data from the memory 515 and/or the storage device 530 to the cache 512 for quick access by the processor 510. In this way, the cache can provide a performance boost that avoids processor 510 delays while waiting for data. These and other modules can control or be configured to control the processor 510 to perform various actions. Other system memory 515 may be available for use as well. The memory 515 can include multiple different types of memory with different performance characteristics. The processor 510 can include any general purpose processor and a hardware module or software module, such as module 1 532, module 2 534, and module 3 536 stored in storage device 530, configured to control the processor 510 as well as a special-purpose processor where software instructions are incorporated into the actual processor design. The processor 510 may essentially be a completely self-contained computing system, containing multiple cores or processors, a bus, memory controller, cache, etc. A multi-core processor may be symmetric or asymmetric.

To enable user interaction with the computing device 500, an input device 545 can represent any number of input mechanisms, such as a microphone for speech, a touch-sensitive screen for gesture or graphical input, keyboard, mouse, motion input, speech and so forth. An output device 535 can also be one or more of a number of output mechanisms known to those of skill in the art. In some instances, multimodal systems can enable a user to provide multiple types of input to communicate with the computing device 500. The communications interface 540 can generally govern and manage the user input and system output. There is no restriction on operating on any particular hardware arrangement and therefore the basic features here may easily be substituted for improved hardware or firmware arrangements as they are developed.

Storage device 530 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 525, read only memory (ROM) 520, and hybrids thereof.

The storage device 530 can include software modules 532, 534, 536 for controlling the processor 510. Other hardware or software modules are contemplated. The storage device 530 can be connected to the system bus 505. In one aspect, a hardware module that performs a particular function can include the software component stored in a computer-readable medium in connection with the necessary hardware components, such as the processor 510, bus 505, display 535, and so forth, to carry out the function.

FIG. 5B illustrates a computer system 550 having a chipset architecture that can be used in executing the described method and generating and displaying a graphical user interface (GUI). Computer system 550 is an example of computer hardware, software, and firmware that can be used to implement the disclosed technology. System 550 can include a processor 555, representative of any number of physically and/or logically distinct resources capable of executing software, firmware, and hardware configured to perform identified computations. Processor 555 can communicate with a chipset 560 that can control input to and output from processor 555. In this example, chipset 560 outputs information to output 565, such as a display, and can read and write information to storage device 570, which can include magnetic media, and solid state media, for example. Chipset 560 can also read data from and write data to RAM 575. A bridge 540 for interfacing with a variety of user interface components 545 can be provided for interfacing with chipset 560. Such user interface components 545 can include a keyboard, a microphone, touch detection and processing circuitry, a pointing device, such as a mouse, and so on. In general, inputs to system 550 can come from any of a variety of sources, machine generated and/or human generated.

Chipset 560 can also interface with one or more communication interfaces 590 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 555 analyzing data stored in storage 570 or 575. Further, the machine can receive inputs from a user via user interface components 545 and execute appropriate functions, such as browsing functions by interpreting these inputs using processor 555.

It can be appreciated that exemplary systems 500 and 550 can have more than one processor 510 or be part of a group or cluster of computing devices networked together to provide greater processing capability.

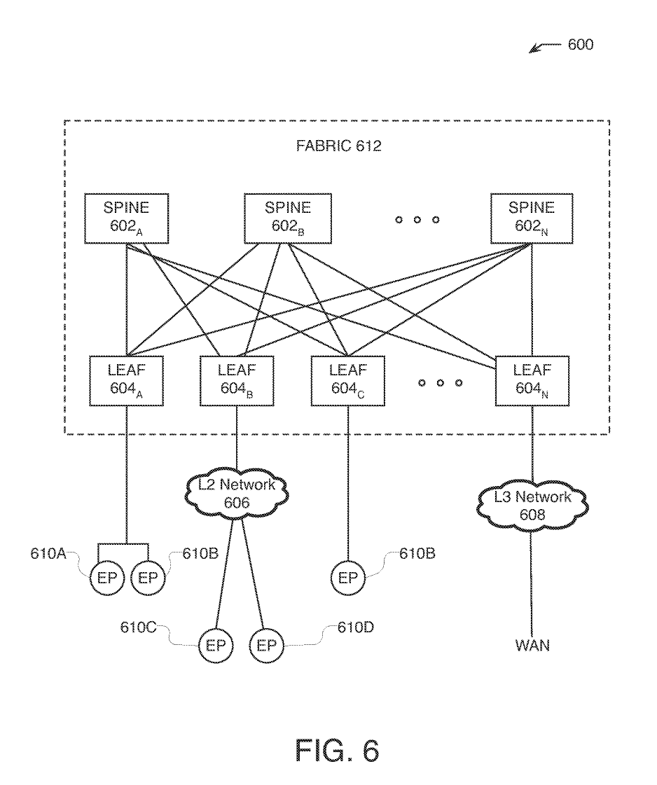

FIG. 6 illustrates a schematic block diagram of an example architecture 600 for a network fabric 612. The network fabric 612 can include spine switches 602A, 602B, . . . , 602N (collectively “602”) connected to leaf switches 604A, 604B, 604C, . . . , 604N (collectively “604”) in the network fabric 612.

Spine switches 602 can be L3 switches in the fabric 612. However, in some cases, the spine switches 602 can also, or otherwise, perform L2 functionalities. Further, the spine switches 602 can support various capabilities, such as 40 or 10 Gbps Ethernet speeds. To this end, the spine switches 602 can include one or more 40 Gigabit Ethernet ports. Each port can also be split to support other speeds. For example, a 40 Gigabit Ethernet port can be split into four 10 Gigabit Ethernet ports.

In some embodiments, one or more of the spine switches 602 can be configured to host a proxy function that performs a lookup of the endpoint address identifier to locator mapping in a mapping database on behalf of leaf switches 604 that do not have such mapping. The proxy function can do this by parsing through the packet to the encapsulated, tenant packet to get to the destination locator address of the tenant. The spine switches 602 can then perform a lookup of their local mapping database to determine the correct locator address of the packet and forward the packet to the locator address without changing certain fields in the header of the packet.

When a packet is received at a spine switch 602i, the spine switch 602i can first check if the destination locator address is a proxy address. If so, the spine switch 602i can perform the proxy function as previously mentioned. If not, the spine switch 602i can lookup the locator in its forwarding table and forward the packet accordingly.

Spine switches 602 connect to leaf switches 604 in the fabric 612. Leaf switches 604 can include access ports (or non-fabric ports) and fabric ports. Fabric ports can provide uplinks to the spine switches 602, while access ports can provide connectivity for devices, hosts, endpoints, VMs, or external networks to the fabric 612.

Leaf switches 604 can reside at the edge of the fabric 612, and can thus represent the physical network edge. In some cases, the leaf switches 604 can be top-of-rack (“ToR”) switches configured according to a ToR architecture. In other cases, the leaf switches 604 can be aggregation switches in any particular topology, such as end-of-row (EoR) or middle-of-row (MoR) topologies. The leaf switches 604 can also represent aggregation switches, for example.

The leaf switches 604 can be responsible for routing and/or bridging the tenant packets and applying network policies. In some cases, a leaf switch can perform one or more additional functions, such as implementing a mapping cache, sending packets to the proxy function when there is a miss in the cache, encapsulate packets, enforce ingress or egress policies, etc.

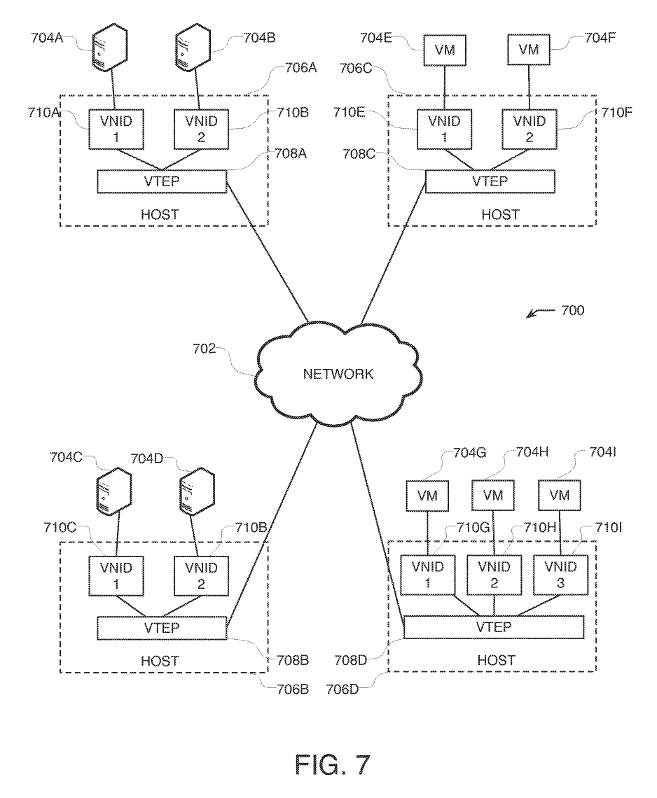

Moreover, the leaf switches 604 can contain virtual switching functionalities, such as a virtual tunnel endpoint (VTEP) function as explained below in the discussion of VTEP 708 in FIG. 7. To this end, leaf switches 604 can connect the fabric 612 to an overlay network, such as overlay network 700 illustrated in FIG. 7.

Network connectivity in the fabric 612 can flow through the leaf switches 604. Here, the leaf switches 604 can provide servers, resources, endpoints, external networks, or VMs access to the fabric 612, and can connect the leaf switches 604 to each other. In some cases, the leaf switches 604 can connect EPGs to the fabric 612 and/or any external networks. Each EPG can connect to the fabric 612 via one of the leaf switches 604, for example.

Endpoints 610A-E (collectively “610”) can connect to the fabric 612 via leaf switches 604. For example, endpoints 610A and 610B can connect directly to leaf switch 604A, which can connect endpoints 610A and 610B to the fabric 612 and/or any other one of the leaf switches 604. Similarly, endpoint 610E can connect directly to leaf switch 604C, which can connect endpoint 610E to the fabric 612 and/or any other of the leaf switches 604. On the other hand, endpoints 610C and 610D can connect to leaf switch 604B via L2 network 606. Similarly, the wide area network (WAN) can connect to the leaf switches 604C or 604D via L3 network 608.

Endpoints 610 can include any communication device, such as a computer, a server, a switch, a router, etc. In some cases, the endpoints 610 can include a server, hypervisor, or switch configured with a VTEP functionality which connects an overlay network, such as overlay network 400 below, with the fabric 612. For example, in some cases, the endpoints 610 can represent one or more of the VTEPs 708A-D illustrated in FIG. 7. Here, the VTEPs 708A-D can connect to the fabric 612 via the leaf switches 604. The overlay network can host physical devices, such as servers, applications, EPGs, virtual segments, virtual workloads, etc. In addition, the endpoints 610 can host virtual workload(s), clusters, and applications or services, which can connect with the fabric 612 or any other device or network, including an external network. For example, one or more endpoints 610 can host, or connect to, a cluster of load balancers or an EPG of various applications.

Although the fabric 612 is illustrated and described herein as an example leaf-spine architecture, one of ordinary skill in the art will readily recognize that the subject technology can be implemented based on any network fabric, including any data center or cloud network fabric. Indeed, other architectures, designs, infrastructures, and variations are contemplated herein.

FIG. 7 illustrates an exemplary overlay network 700. Overlay network 700 uses an overlay protocol, such as VXLAN, VGRE, VO3, or STT, to encapsulate traffic in L2 and/or L3 packets which can cross overlay L3 boundaries in the network. As illustrated in FIG. 7, overlay network 700 can include hosts 706A-D interconnected via network 702.

Network 702 can include a packet network, such as an IP network, for example. Moreover, network 702 can connect the overlay network 700 with the fabric 312 in FIG. 3. For example, VTEPs 708A-D can connect with the leaf switches 304 in the fabric 312 via network 702.

Hosts 706A-D include virtual tunnel end points (VTEP) 708A-D, which can be virtual nodes or switches configured to encapsulate and decapsulate data traffic according to a specific overlay protocol of the network 700, for the various virtual network identifiers (VNIDs) 710A-I. Moreover, hosts 706A-D can include servers containing a VTEP functionality, hypervisors, and physical switches, such as L3 switches, configured with a VTEP functionality. For example, hosts 706A and 706B can be physical switches configured to run VTEPs 708A-B. Here, hosts 706A and 706B can be connected to servers 704A-D, which, in some cases, can include virtual workloads through VMs loaded on the servers, for example.

In some embodiments, network 700 can be a VXLAN network, and VTEPs 708A-D can be VXLAN tunnel end points. However, as one of ordinary skill in the art will readily recognize, network 700 can represent any type of overlay or software-defined network, such as NVGRE, STT, or even overlay technologies yet to be invented.

The VNIDs can represent the segregated virtual networks in overlay network 700. Each of the overlay tunnels (VTEPs 708A-D) can include one or more VNIDs. For example, VTEP 708A can include VNIDs 1 and 2, VTEP 708B can include VNIDs 1 and 3, VTEP 708C can include VNIDs 1 and 2, and VTEP 708D can include VNIDs 1-3. As one of ordinary skill in the art will readily recognize, any particular VTEP can, in other embodiments, have numerous VNIDs, including more than the 3 VNIDs illustrated in FIG. 7.

The traffic in overlay network 700 can be segregated logically according to specific VNIDs. This way, traffic intended for VNID 1 can be accessed by devices residing in VNID 1, while other devices residing in other VNIDs (e.g., VNIDs 2 and 3) can be prevented from accessing such traffic. In other words, devices or endpoints connected to specific VNIDs can communicate with other devices or endpoints connected to the same specific VNIDs, while traffic from separate VNIDs can be isolated to prevent devices or endpoints in other specific VNIDs from accessing traffic in different VNIDs.

Servers 704A-D and VMs 704E-I can connect to their respective VNID or virtual segment, and communicate with other servers or VMs residing in the same VNID or virtual segment. For example, server 704A can communicate with server 704C and VMs 704E and 704G because they all reside in the same VNID, viz., VNID 1. Similarly, server 704B can communicate with VMs 704F, H because they all reside in VNID 2. VMs 704E-I can host virtual workloads, which can include application workloads, resources, and services, for example. However, in some cases, servers 704A-D can similarly host virtual workloads through VMs hosted on the servers 704A-D. Moreover, each of the servers 704A-D and VMs 704E-I can represent a single server or VM, but can also represent multiple servers or VMs, such as a cluster of servers or VMs.

VTEPs 708A-D can encapsulate packets directed at the various VNIDs 1-3 in the overlay network 700 according to the specific overlay protocol implemented, such as VXLAN, so traffic can be properly transmitted to the correct VNID and recipient(s). Moreover, when a switch, router, or other network device receives a packet to be transmitted to a recipient in the overlay network 700, it can analyze a routing table, such as a lookup table, to determine where such packet needs to be transmitted so the traffic reaches the appropriate recipient. For example, if VTEP 708A receives a packet from endpoint 704B that is intended for endpoint 704H, VTEP 708A can analyze a routing table that maps the intended endpoint, endpoint 704H, to a specific switch that is configured to handle communications intended for endpoint 704H. VTEP 708A might not initially know, when it receives the packet from endpoint 704B, that such packet should be transmitted to VTEP 708D in order to reach endpoint 704H. Accordingly, by analyzing the routing table, VTEP 708A can lookup endpoint 704H, which is the intended recipient, and determine that the packet should be transmitted to VTEP 708D, as specified in the routing table based on endpoint-to-switch mappings or bindings, so the packet can be transmitted to, and received by, endpoint 704H as expected.

However, continuing with the previous example, in many instances, VTEP 708A may analyze the routing table and fail to find any bindings or mappings associated with the intended recipient, e.g., endpoint 704H. Here, the routing table may not yet have learned routing information regarding endpoint 704H. In this scenario, the VTEP 708A may likely broadcast or multicast the packet to ensure the proper switch associated with endpoint 704H can receive the packet and further route it to endpoint 704H.

In some cases, the routing table can be dynamically and continuously modified by removing unnecessary or stale entries and adding new or necessary entries, in order to maintain the routing table up-to-date, accurate, and efficient, while reducing or limiting the size of the table.

As one of ordinary skill in the art will readily recognize, the examples and technologies provided above are simply for clarity and explanation purposes, and can include many additional concepts and variations.

As one of ordinary skill in the art will readily recognize, the examples and technologies provided above are simply for clarity and explanation purposes, and can include many additional concepts and variations.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims. Moreover, claim language reciting “at least one of” a set indicates that one member of the set or multiple members of the set satisfy the claim.

What is claimed is:

1. A system, comprising:
at least one processor;
an interface;
a local storage device; and
memory including instructions that, when executed by the at least one processor, cause the system to:
store, at a shared storage device, a plurality of boot volume images corresponding to an operating system and respective configurations for a virtual machine;
select a boot volume image from the plurality of boot volume images, the boot volume image including at least configuration information for a new virtual machine;
for installing the new virtual machine using the configuration information:
load a first set of data into the memory from the selected boot volume image, the first set of data including at least a boot loader enabled to load at least a portion of the operating system into the memory and perform a boot process for the new virtual machine; and
store, using the interface, a second set of data into the local storage device, the second set of data including data for executing the operating system after performing the boot process for the new virtual machine.

2. The system of claim 1, wherein the plurality of boot volume images, stored at the shared storage device, include at least one boot volume image that includes a set of custom boot volume changes for a respective virtual machine.

3. The system of claim 1, wherein to select the boot volume image is based at least in part on a time in which each of the plurality of boot volume images was created.

4. The system of claim 1, wherein each of the plurality of boot volume images include a version of a kernel of the operating system and a set of drivers.

5. The system of claim 1, wherein the memory includes further instructions, when executed by the at least one processor, further cause the system to:
select a second boot volume image from the plurality of boot volume images, the second boot volume image being newer than the boot volume image and including at least one different set of data than the boot volume image; and
perform a boot process for a new second virtual machine using the selected second boot volume.

6. The system of claim 1, wherein the memory includes further instructions, when executed by the at least one processor, further cause the system to:
receive a read request for a block of data on a virtual disk stored in the local storage device, the virtual disk corresponding to the new virtual machine;
determine whether the read request was successful for the block of data on the virtual disk; and
responsive to the read request being unsuccessful, perform a read operation for the block of data on the selected boot volume image stored at the shared storage device.

7. The system of claim 6, wherein the memory includes further instructions, when executed by the at least one processor, further cause the system to:
perform a write operation for a second block of data on the virtual disk corresponding to the new virtual machine; and
generate, in an access log stored at the local storage device, a log entry including information corresponding to the write operation.

8. The system of claim 6, wherein the memory includes further instructions, when executed by the at least one processor, further cause the system to:
generate, in an access log stored at the local storage device, a log entry including information corresponding to the read operation.

9. The system of claim 1, wherein a hypervisor installs the new virtual machine.

10. A computer-implemented method, comprising:
storing, at a shared storage device, a plurality of boot volume images corresponding to an operating system and respective configurations for a virtual machine;
selecting a boot volume image from the plurality of boot volume images, the boot volume image including at least configuration information for a new virtual machine;
for installing the new virtual machine using the configuration information:
loading a first set of data into memory from the selected boot volume image, the first set of data including at least a boot loader enabled to load at least a portion of the operating system into the memory and perform a boot process for the new virtual machine; and
storing a second set of data into a local storage device, the second set of data including data for executing the operating system after performing the boot process for the new virtual machine.

11. The computer-implemented method of claim 10, wherein the plurality of boot volume images, stored at the shared storage device, include at least one boot volume image that includes a set of custom boot volume changes for a respective virtual machine.

12. The computer-implemented method of claim 10, wherein selecting the boot volume image is based at least in part on a time in which each of the plurality of boot volume images was created.

13. The computer-implemented method of claim 10, wherein each of the plurality of boot volume images include a version of a kernel of the operating system and a set of drivers.

14. The computer-implemented method of claim 10, further comprising:
selecting a second boot volume image from the plurality of boot volume images, the second boot volume image being newer than the boot volume image and including at least one different set of data than the boot volume image; and
performing a boot process for a new second virtual machine using the selected second boot volume.

15. The computer-implemented method of claim 10, further comprising:
receiving a read request for a block of data on a virtual disk stored in the local storage device, the virtual disk corresponding to the new virtual machine;
determining whether the read request was successful for the block of data on the virtual disk; and
responsive to the read request being unsuccessful, performing a read operation for the block of data on the selected boot volume image stored at the shared storage device.

16. The computer-implemented method of claim 15, further comprising:
performing a write operation for a second block of data on the virtual disk corresponding to the new virtual machine; and
generating, in an access log stored at the local storage device, a log entry including information corresponding to the write operation.

17. The computer-implemented method of claim 15, further comprising:
generating, in an access log stored at the local storage device, a log entry including information corresponding to the read operation.

18. The computer-implemented method of claim 10, wherein a hypervisor installs the new virtual machine.

19. A non-transitory computer-readable medium including instructions stored therein that, when executed by at least one computing device, cause the at least one computing device to:
store, at a shared storage device, a plurality of boot volume images corresponding to an operating system and respective configurations for a virtual machine;
select a boot volume image from the plurality of boot volume images, the boot volume image including at least configuration information for a new virtual machine;
for installing the new virtual machine using the configuration information:
load a first set of data into the memory from the selected boot volume image, the first set of data including at least a boot loader enabled to load at least a portion of the operating system into the memory and perform a boot process for the new virtual machine; and
store, using the interface, a second set of data into the local storage device, the second set of data including data for executing the operating system after performing the boot process for the new virtual machine.

20. The non-transitory computer-readable medium of claim 19, including further instructions that cause the at least one computing device to:
select a second boot volume image from the plurality of boot volume images, the second boot volume image being newer than the boot volume image and including at least one different set of data than the boot volume image; and
perform a boot process for a new second virtual machine using the selected second boot volume.
